(19) United States
(12) Patent Application Publication
(10) Pub. No.: US 2023/0067966 A1
(43) Pub. Date: Mar. 2, 2023

(54) IMAGE FORMING APPARATUS

(71) Applicant: FUJIFILM Business Innovation Corp., Tokyo (JP)

(72) Inventors: Kenta Tonosu, Kanagawa (JP); Yosuke Kasuya, Kanagawa (JP); Takahiko Kobayashi, Kanagawa (JP)

(73) Assignee: FUJIFILM Business Innovation Corp., Tokyo (JP)

(21) Appl. No.: 17/590,343

(22) Filed: Feb. 1, 2022

(30) Foreign Application Priority Data
Aug. 25, 2021 (JP) 2021-137618

(51) Int. Cl. G03G 15/043; G03G 21/16

(52) U.S. Cl. CPC G03G 15/043; G03G 21/1666

(57) ABSTRACT

An image forming apparatus includes: a rotatable image carrier on an outer circumferential surface of which an image is to be formed and that is movable in a rotation axis direction between an image forming position and a maintenance position; a light-emitting unit including a base member extending in the rotation axis direction of the image carrier, and plural light-emitting devices provided on the base member and configured to apply light to the outer circumferential surface of the image carrier, the light-emitting unit being configured to move together with the image carrier in the rotation axis direction; and a supporting unit configured to move together with the image carrier in the rotation axis direction and to support the light-emitting unit when the image carrier and the light-emitting unit are at the maintenance position and the light-emitting unit is disabled from being positioned with respect to the image carrier.

### CROSS-REFERENCE TO RELATED APPLICATIONS

This application is based on and claims priority under 35 USC 119 from Japanese Patent Application No. 2021-137618 filed Aug. 25, 2021.

### BACKGROUND

### (i) Technical Field

The present disclosure relates to an image forming apparatus.

### (ii) Related Art

An image forming apparatus disclosed by Japanese Unexamined Patent Application Publication No. 2020-97169 includes an image-forming-apparatus body that houses an image forming unit, a covering member that is openably provided on the image-forming-apparatus body, and an opening-and-closing device that opens and closes the covering member. The opening-and-closing device includes a first locking member and a second locking member that lock the covering member to the image-forming-apparatus body, a first connecting member connected to the first locking member, and a second connecting member that connects the first connecting member and the second locking member to each other such that the second locking member moves toward the first locking member when the first connecting member is moved in such a direction that the locking by the first locking member is disabled.

### SUMMARY

Aspects of non-limiting embodiments of the present disclosure relate to an image forming apparatus that provides greater ease of maintenance work than an apparatus in which a light-emitting unit is to be supported by an operator during the maintenance work.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a rotatable image carrier on an outer circumferential surface of which an image is to be formed and that is movable in a rotation axis direction between an image forming position and a maintenance position; a light-emitting unit including a base member extending in the rotation axis direction of the image carrier, and a plurality of light-emitting devices provided on the base member and configured to apply light to the outer circumferential surface of the image carrier, the light-emitting unit being configured to move together with the image carrier in the rotation axis direction; and a supporting unit configured to move together with the image carrier in the rotation axis direction and to support the light-emitting unit when the image carrier and the light-emitting unit are at the maintenance position and the light-emitting unit is disabled from being positioned with respect to the image carrier.

### BRIEF DESCRIPTION OF THE DRAWINGS

An exemplary embodiment of the present disclosure will be described in detail based on the following figures, wherein:

FIG. 1 schematically illustrates an image forming apparatus including exposure devices according to the exemplary embodiment;

FIG. 2 is a side view of a representative one of the exposure devices included in the image forming apparatus, illustrating an adjusting unit and a pressing unit that are provided on one side in the depth direction of the exposure device;

FIG. 3 is a partially sectional side view of the adjusting unit and the pressing unit included in the exposure device;

FIG. 4 is a partially sectional front view of the adjusting unit and the pressing unit included in the exposure device;

FIG. 5 is a plan view of a light-emitting unit;

FIG. 6 is a front view of the adjusting unit and the pressing unit, corresponding to FIG. 4, with the pressing unit being disabled from pressing the light-emitting unit;

FIG. 7 is a front view of the adjusting unit and the pressing unit, corresponding to FIG. 6, with the light-emitting unit being moved in a direction opposite to a direction of light emission;

FIG. 8 is a front view of the adjusting unit and the pressing unit, corresponding to FIG. 7, with the light-emitting unit being moved in a detaching direction;

FIG. 9 is a partially sectional front view of an adjusting unit and a pressing unit included in another representative one of the exposure devices;

FIG. 10 is a front view of the adjusting unit and the pressing unit included in the exposure device, corresponding to FIG. 9, with the pressing unit being disabled from pressing the light-emitting unit;

FIG. 11 is a front view of the adjusting unit and the pressing unit included in the exposure device, corresponding to FIG. 10, with the light-emitting unit being moved in a detaching direction;

FIG. 12 schematically illustrates an image forming apparatus according to a modification;

FIG. 13 is a side view of an exposure device according to another modification;

FIG. 14 is a side view of the exposure device, corresponding to FIG. 13, with a pressing unit being disabled from pressing a light-emitting unit;

FIG. 15 is a side view of the exposure device, corresponding to FIG. 14, with the light-emitting unit being retracted in a detaching direction;

FIG. 16A is a front view of an arm of a separating unit illustrated in FIG. 13 and seen in the direction of arrow XVIA;

FIG. 16B is a front view of the arm of the separating unit illustrated in FIG. 14 and seen in the direction of arrow XVIB; and

FIG. 16C is a front view of the arm of the separating unit illustrated in FIG. 15 and seen in the direction of arrow XVIC.

### DETAILED DESCRIPTION

### Image Forming Apparatus 10

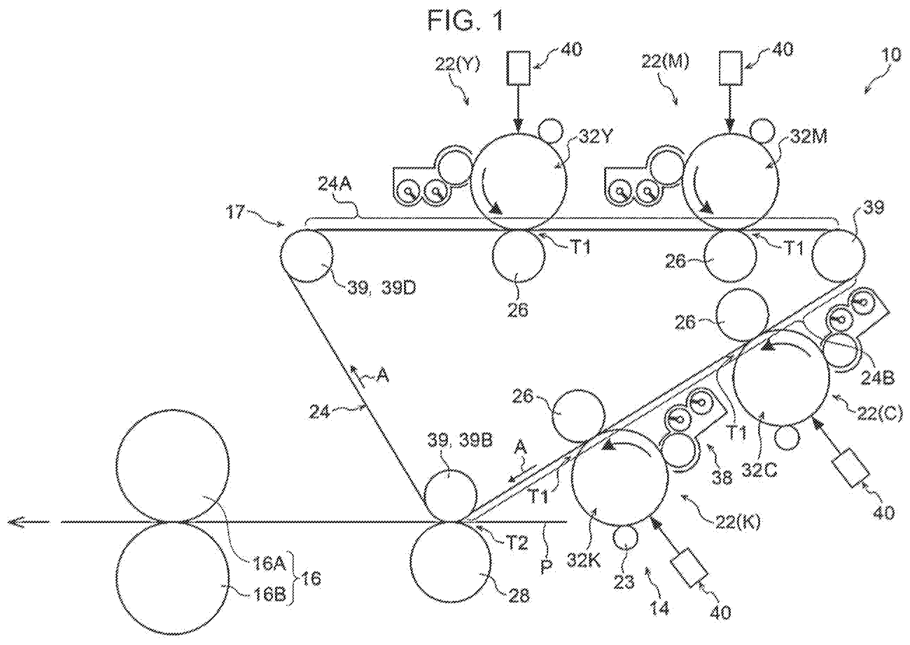

FIG. 1 schematically illustrates an image forming apparatus 10 including exposure devices 40 according to an exemplary embodiment. A configuration of the image forming apparatus 10 will first be described. Then, the exposure devices 40 included in the image forming apparatus 10 will be described. The image forming apparatus 10 forms an image composed of, for example, a plurality of colors and is a full-color printer intended for, for example, commercial printing that is to be of high image quality.

The image forming apparatus 10 is capable of handling wide recording media, P, having a width greater than the portrait width of B3 media (i.e., a width greater than 364 mm). For example, the image forming apparatus 10 is capable of handling recording media P having a width ranging from 420 mm, which is the portrait width of A2 media, to 1456 mm, which is the landscape width of B0 media, inclusive. As a specific example, the image forming apparatus 10 is capable of handling recording media P having a width of 728 mm, which is the landscape width of B2 media.

The image forming apparatus 10 illustrated in FIG. 1 is an exemplary image forming apparatus that forms an image on a recording medium. Specifically, the image forming apparatus 10 is an electrophotographic image forming apparatus that forms a toner image (an exemplary image) on a recording medium P. Toners are exemplary particles. The image forming apparatus 10 includes an image forming section 14 and a fixing device 16. Relevant elements (the image forming section 14 and the fixing device 16) of the image forming apparatus 10 will now be described.

### Image Forming Section 14

The image forming section 14 has a function of forming a toner image on a recording medium P. The image forming section 14 includes a plurality of toner-image-forming units 22 and a transfer device 17.

### Toner-Image-Forming Units 22

The plurality of toner-image-forming units 22 illustrated in FIG. 1 are provided for forming toner images in respective colors. In the present exemplary embodiment, four toner-image-forming units 22 are provided for four colors of yellow (Y), magenta (M), cyan (C), and black (K). Reference characters (Y), (M), (C), and (K) provided in FIG. 1 each indicate for which of the foregoing colors the element denoted is provided.

The toner-image-forming units 22 for the respective colors all have the same configuration, except the toners to be used. Therefore, in FIG. 1, reference signs for details are given to the toner-image-forming unit 22(K), representing all the toner-image-forming units 22.

The toner-image-forming units 22 each include a photoconductor drum 32, which is rotatable in one direction (counterclockwise in FIG. 1, for example). The photoconductor drum 32 is an exemplary image carrier. The toner-image-forming units 22 each further include a charging device 23, an exposure device 40, and a developing device 38.

In each of the toner-image-forming units 22, the charging device 23 charges the photoconductor drum 32. Furthermore, the exposure device 40 exposes the photoconductor drum 32 charged by the charging device 23 to light, thereby forming an electrostatic latent image on the photoconductor drum 32. Furthermore, the developing device 38 develops the electrostatic latent image formed on the photoconductor drum 32 by the exposure device 40 into a toner image.

The photoconductor drum 32 carrying the electrostatic latent image formed as above on the outer circumference thereof rotates to transport the electrostatic latent image to the developing device 38. Details of the exposure device 40 will be described separately below.

### Transfer Device 17

The transfer device 17 illustrated in FIG. 1 transfers toner images formed by the respective toner-image-forming units 22 to a recording medium P. Specifically, in the transfer device 17, toner images formed on the respective photoconductor drums 32 are first-transferred to a transfer belt 24 (an intermediate transfer body) in such a manner as to be superposed one on top of another, and the combination of the toner images (hereinafter simply referred to as “toner image”) is second-transferred to a recording medium P. As illustrated in FIG. 1, the transfer device 17 includes the transfer belt 24, first transfer rollers 26, and a second transfer roller 28.

The first transfer rollers 26 transfer the toner images on the respective photoconductor drums 32 to the transfer belt 24 at respective first transfer positions T1, which are defined between the photoconductor drums 32 and the respective first transfer rollers 26. In the present exemplary embodiment, a first-transfer electric field is generated between each of the first transfer rollers 26 and a corresponding one of the photoconductor drums 32. With the first-transfer electric field, the toner image formed on the photoconductor drum 32 is transferred to the transfer belt 24 at the first transfer position T1.

The transfer belt 24 receives the toner images from the respective photoconductor drums 32 by the outer circumferential surface thereof. As illustrated in FIG. 1, the transfer belt 24 has an annular shape and is positioned by being stretched around a plurality of rollers 39.

The plurality of rollers 39 include a driving roller 39D, for example. When the driving roller 39D is driven by a driving unit (not illustrated) to rotate, the transfer belt 24 circulates in a direction represented by arrow A. As illustrated in FIG. 1, the plurality of rollers 39 further include a counter roller 39B, which is positioned against the second transfer roller 28.

The second transfer roller 28 transfers the toner image on the transfer belt 24 to a recording medium P at a second transfer position T2, which is defined between the counter roller 39B and the second transfer roller 28. In the present exemplary embodiment, a second-transfer electric field is generated between the counter roller 39B and the second transfer roller 28. With the second-transfer electric field, the toner image transferred to the transfer belt 24 is transferred to a recording medium P at the second transfer position T2.

As illustrated in FIG. 1, the transfer belt 24 (an exemplary transfer member) according to the present exemplary embodiment includes a horizontal portion 24A, which extends in the horizontal direction; and an angled portion 24B, which is angled with respect to the vertical direction.

### Fixing Device 16

The fixing device 16 illustrated in FIG. 1 fixes the toner image transferred to a recording medium P by the second transfer roller 28 on the recording medium P. As illustrated in FIG. 1, the fixing device 16 includes a heating roller 16A (a heating member) and a pressing roller 16B (a pressing member). In the fixing device 16, the heating roller 16A and the pressing roller 16B apply heat and pressure to the recording medium P, thereby fixing the toner image on the recording medium P.

### Exposure Devices 40

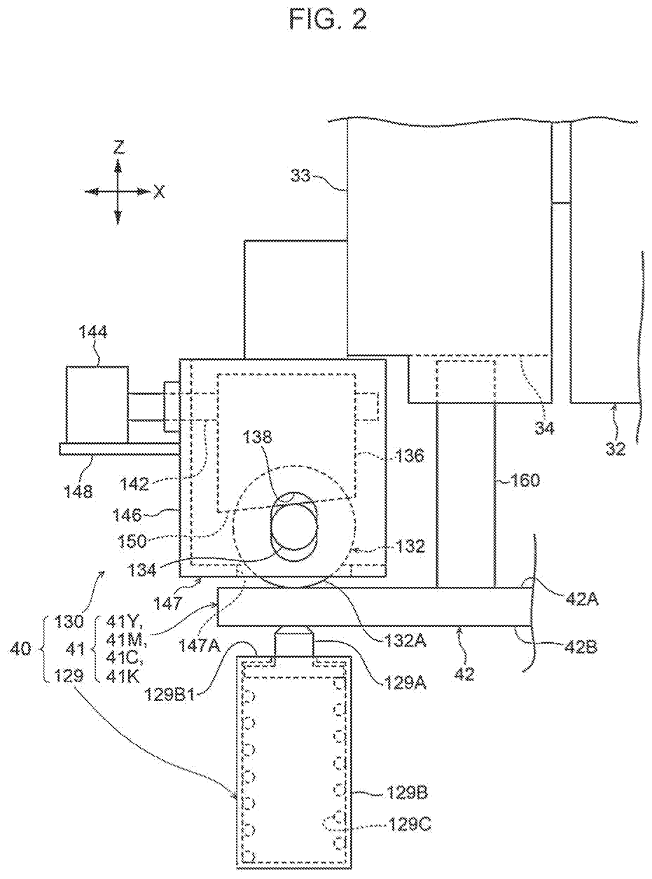

Configurations of the exposure devices 40 according to the present exemplary embodiment will now be described. FIG. 2 is a side view of a representative one of the exposure devices 40. The following description is based on a definition that, in relevant drawings, the Y axis represents the width direction of the exposure device 40 (hereinafter referred to as the device-width direction), the Z axis represents the height direction of the exposure device 40 (hereinafter referred to as the device-height direction), and the X axis represents the depth direction of the exposure device 40 (hereinafter referred to as the device-depth direction) that is orthogonal to both the device-width direction and the device-height direction. Note that the device-width direction and the device-height direction are defined for the convenience of description, and the configuration of the exposure device 40 is not limited by such directions.

First, an outline of the exposure device 40 will be described, followed by description of relevant elements included in the exposure device 40.

Referring to FIG. 2, the exposure device 40 includes a light-emitting unit 41, a position adjusting unit 130, and a pressing unit 129.

### Light-Emitting Unit 41

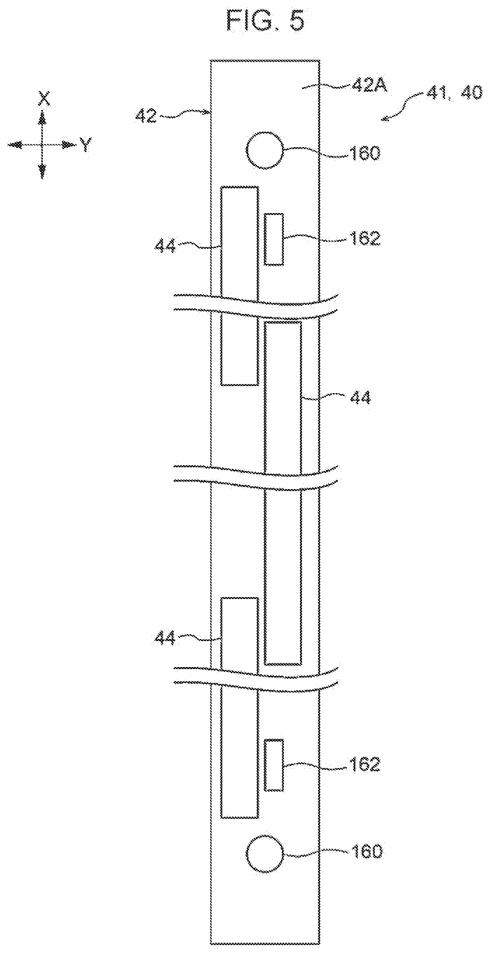

Referring to FIG. 5, the light-emitting unit 41 includes a base member 42 and a plurality of light emitters 44. The base member 42 extends in one direction (the X direction, in the present exemplary embodiment). The light emitters 44 are provided on a surface of the base member 42 that is on one side in the Z direction. In the present exemplary embodiment, three light emitters 44 are provided on the base member 42. The light emitters 44 each extend in the one direction of the base member 42. The base member 42 has a long, narrow, rectangular shape in plan view as illustrated in FIG. 5. The light emitters 44 all have the same configuration and each have a long, narrow, rectangular shape in plan view as illustrated in FIG. 5.

As an exemplary arrangement, the three light emitters 44 are staggered both in the one direction of the base member 42, i.e., in the long-side direction (the X direction) of the base member 42 and in the width direction of the base member 42 that is orthogonal to the one direction of the base member 42, i.e., in the short-side direction (the Y direction) of the base member 42. The light-emitting unit 41 extends in the axial direction of the photoconductor drum 32 (see FIG. 1). The length of the light-emitting unit 41 in the one direction is greater than or equal to the axial length of the photoconductor drum 32. At least one of the three light emitters 44 is positioned facing the surface (outer circumferential surface) of the photoconductor drum 32. Thus, light emitted from the light-emitting unit 41 is applied to the surface of the photoconductor drum 32.

If the light-emitting unit 41 has a single light emitter 44, the direction of light emission from the light-emitting unit 41 to the photoconductor drum 32 is regarded as the direction of the optical axis of the single light emitter 44. If the light-emitting unit 41 has a plurality of light emitters 44 as in the present exemplary embodiment, the direction of light emission is regarded as, seen in the one direction (X direction) of the base member 42, the direction of a virtual line extending from the midpoint between the principal points of the light emitters 44 in the short-side direction (Y direction) of the base member 42 to a point to be focused on. In the present exemplary embodiment, the position and angle of the light-emitting unit 41 are adjusted such that a virtual line extending in the direction of light emission passes through the center of the photoconductor drum 32.

In the present exemplary embodiment, the three light emitters 44 are arranged in a staggered manner in the plan view of the light-emitting unit 41 (see FIG. 5). More specifically, two of the three light emitters 44 that are at the two respective ends of the base member 42 in the one direction are positioned on one side in the short-side direction of the base member 42. The remaining one light emitter 44 in a central part of the base member 42 in the one direction is positioned on the other side in the short-side direction of the base member 42. Seen in the short-side direction of the base member 42, one end of each of the two light emitters 44 positioned on the one side in the short-side direction of the base member 42 overlaps a corresponding one of the ends of the one light emitter 44 positioned on the other side in the short-side direction of the base member 42. That is, in the one direction of the base member 42, the areas of light emission from the three respective light emitters 44 overlap one another in part.

In the present exemplary embodiment, description of elements provided for activating the light-emitting unit 41, including a driving circuit board, a power source, and wires, is omitted.

The light emitters 44 illustrated in FIG. 5 each have a plurality of light sources (not illustrated) arrayed in the one direction (X direction). The light sources according to the present exemplary embodiment include, for example, a plurality of light-emitting devices. An example of such a light source is a light-emitting-device array including a semiconductor substrate and a plurality of light-emitting devices that are arrayed in the one direction on the semiconductor substrate. The light source is not limited to such a light-emitting-device array and may be formed of a single light-emitting device. The light-emitting devices may be light-emitting diodes, light-emitting thyristors, laser devices, or the like that are arrayed in the one direction in such a manner as to achieve a resolution of, for example, 2400 dpi.

In the light-emitting unit 41, light beams emitted from the respective light sources pass through a lens unit (not illustrated) and are applied to the surface of the photoconductor drum 32 (see FIG. 1), which is the object of light application.

Referring to FIG. 2, a positioning member 160 is provided between the base member 42 and the photoconductor drum 32. The positioning member 160 determines the position of the light-emitting unit 41 with respect to the photoconductor drum 32 in a direction orthogonal to the direction of light emission. More specifically, the positioning member 160 determines the position of the light-emitting unit 41 in the Y direction, which is one of the directions that are orthogonal to the direction of light emission. In the present exemplary embodiment, the positioning member 160 is provided at each of the two ends of the base member 42 in the long-side direction (X direction) of the base member 42. FIG. 2 illustrates one of the two positioning members 160 that is provided at one of the two ends of the base member 42 in the long-side direction (X direction), specifically, on the near side in the device-depth direction.

The positioning member 160 determines the position thereof with respect to the photoconductor drum 32 in the Y direction by coming into contact with a drum flange 33. Specifically, the positioning member 160 is a round columnar projection projecting from the front surface, 42A, of the base member 42 toward the drum flange 33. The shape of the positioning member 160 is not limited to such a round columnar projection. The positioning member 160 may have any other shape such as a prism shape or an elliptic columnar shape. The positioning member 160 in the form of a round columnar projection is to be fitted into a restraining portion 34, which is provided in the drum flange 33. In the present exemplary embodiment, the drum flange 33 is one of a pair of drum flanges 33, by which the two respective axial ends of the photoconductor drum 32 are rotatably supported. The pair of drum flanges 33 are attached to an apparatus body (a frame, not illustrated, of the image forming section 14 in the present exemplary embodiment).

As illustrated in FIG. 2, the restraining portion 34 is a recess extending in the X direction. In other words, the restraining portion 34 is a groove extending in the X direction and having two open ends. When the positioning member 160 is fitted into the restraining portion 34, the positioning member 160 is restrained from moving in the Y direction by wall surfaces in the restraining portion 34 that are opposite each other in the Y direction. That is, the positioning member 160 determines the position of the light-emitting unit 41 in the Y direction by being restrained in the restraining portion 34.

Referring to FIGS. 2 to 4, the position adjusting unit 130 adjusts the distance between the light-emitting unit 41 and the photoconductor drum 32. Specifically, the position adjusting unit 130 adjusts the position of the light-emitting unit 41 with respect to the photoconductor drum 32 in a direction parallel to the direction of light emission. More specifically, the position adjusting unit 130 moves the light-emitting unit 41 in the direction parallel to the direction of light emission, thereby adjusting the position of the light-emitting unit 41 with respect to the photoconductor drum 32 in the direction parallel to the direction of light emission. In the present exemplary embodiment, the direction of light emission from the light-emitting unit 41 substantially coincides with the Z direction.

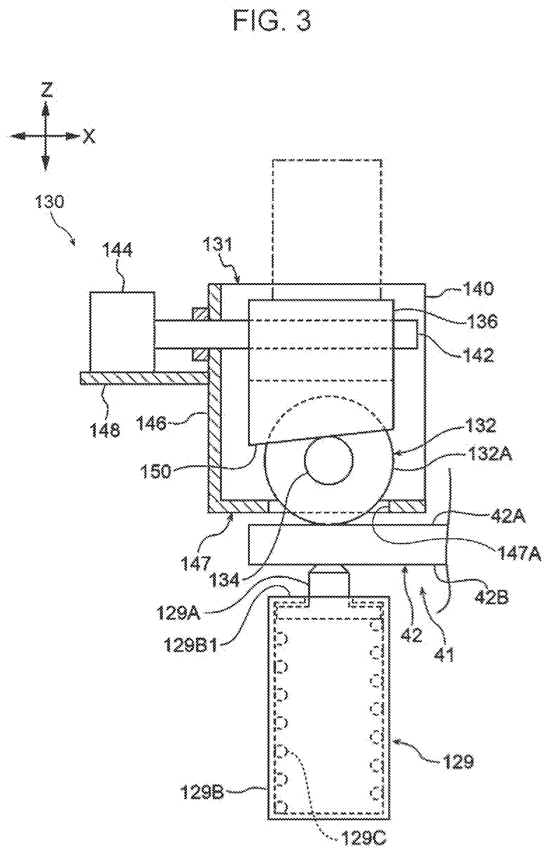

Referring to FIG. 3, the position adjusting unit 130 includes a contact member 132, a shaft 134, and a movable member 136.

As illustrated in FIG. 3, the contact member 132 has an outer circumferential surface 132A, at which the contact member 132 comes into contact with the front surface 42A of the base member 42. The contact member 132 has a disc shape and is rotatably supported by the shaft 134. Specifically, the contact member 132 is supported by the shaft 134 in such a manner as to be capable of undergoing relative rotation on the shaft 134. The contact member 132 according to the present exemplary embodiment is, for example, a ball bearing.

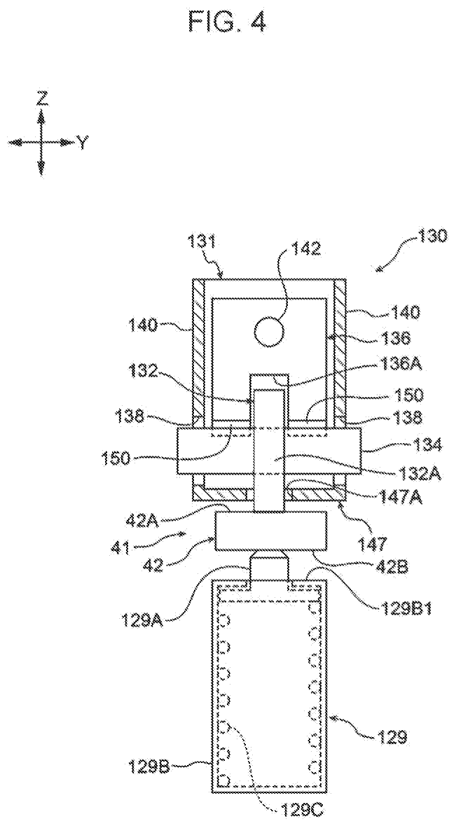

The shaft 134 supports the contact member 132 such that the contact member 132 is capable of undergoing relative rotation on the shaft 134. As illustrated in FIGS. 3 and 4, the shaft 134 is a substantially round columnar member and is received at the two axial ends thereof by a pair of receiving portions 138. The pair of receiving portions 138 are positioned opposite each other in the Y direction, i.e., the short-side direction of the base member 42. The pair of receiving portions 138 receive the shaft 134 such that the shaft 134 is rotatable about the Y axis and is movable in the direction parallel to the direction of light emission. More specifically, the contact member 132 is positioned between the pair of receiving portions 138 that receive the shaft 134.

As illustrated in FIG. 4, the pair of receiving portions 138 are the walls of elongated holes provided respectively in a pair of supporting plates 140, which are provided across the contact member 132 from each other in the Y direction. The elongated holes are elongated in the Z direction. Therefore, the shaft 134 supported at the two axial ends thereof is rotatable and is movable in the direction parallel to the direction of light emission. The two axial ends of the shaft 134 are provided with respective stoppers (not illustrated) that prevent the shaft 134 from coming off.

Referring to FIG. 2, the movable member 136 comes into contact with the shaft 134 and causes the shaft 134 to move in the direction parallel to the direction of light emission from the light-emitting unit 41.

The movable member 136 is movable in the X direction. The position adjusting unit 130 includes a feeding member 142 and a drive source 144, which serves as a driving unit. The movable member 136 is caused to move in the X direction with the aid of the feeding member 142. The feeding member 142 according to the present exemplary embodiment is a feed screw serving as an exemplary screw member. The feeding member 142 extends through a connecting plate 146, which connects the X-direction ends of the pair of supporting plates 140 to each other. The drive source 144 is connected to one axial end of the feeding member 142. The drive source 144 drives the feeding member 142 to rotate. While the drive source 144 according to the present exemplary embodiment is, for example, an electric motor, the present disclosure is not limited to such a case. The drive source 144 is attached to an attaching plate 148, which projects from the connecting plate 146 on one side in the X direction (the left side in FIG. 2, i.e., the near side in the device-depth direction). In the position adjusting unit 130 according to the present exemplary embodiment, the pair of supporting plates 140, the connecting plate 146, and the attaching plate 148 form a housing 131. The housing 131 is attached to a frame (not illustrated) included in the image forming section 14.

The movable member 136 has a converting portion 150, which converts a moving force in the X direction that is exerted by the feeding member 142 into a moving force that causes the shaft 134 to move in the direction parallel to the direction of light emission. Specifically, the converting portion 150 is a slope angled with respect to the X direction and provided at a part of the movable member 136 that comes into contact with the shaft 134. More specifically, referring to FIG. 4, the converting portion 150 included in the movable member 136 is one of a pair of converting portions 150 (a pair of slopes). The pair of converting portions 150 are positioned across the contact member 132 from each other and are in contact with the shaft 134 on the respective sides in the axial direction of the shaft 134. The movable member 136 according to the present exemplary embodiment has, for example, a cubic shape with a groove 136A, which extends in the X direction and is provided in a portion facing the contact member 132. A part of the outer circumference of the contact member 132 is to be received by the groove 136A. That is, the pair of converting portions 150 are positioned across the groove 136A of the movable member 136 from each other.

Referring to FIG. 2, the base member 42 is pressed by the pressing unit 129 toward the position adjusting unit 130. The pressing unit 129 is positioned across the base member 42 from the position adjusting unit 130. That is, the base member 42 is held and pressed in the Z direction between the position adjusting unit 130 and the pressing unit 129. When the movable member 136 moves in the X direction, the slopes serving as the converting portions 150 move on the outer circumferential surface of the shaft 134 and exert a moving force that causes the shaft 134 to move in the Z direction. The moving force in the Z direction thus applied to the shaft 134 is transmitted through the contact member 132 to the base member 42, whereby a pressing protrusion 129A, included in the pressing unit 129, is pushed into the pressing unit 129. Consequently, the base member 42 is moved in the Z direction, that is, the position of the base member 42 is adjusted. Referring to FIGS. 2 to 4, the pressing unit 129 according to the present exemplary embodiment includes the pressing protrusion 129A, a housing 129B, and an urging member 129C. The pressing protrusion 129A comes into contact with the back surface, 42B, of the base member 42 and presses the base member 42 in the direction of light emission. The housing 129B allows the pressing protrusion 129A to be housed therein. The urging member 129C is provided inside the housing 129B and urges the pressing protrusion 129A in the direction of light emission. The urging member 129C may be, for example, a coil spring. However, the present disclosure is not limited to such a configuration. The coil spring employed as the urging member 129C may be replaced with an electrical actuator or the like.

Referring to FIG. 4, seen in the direction of light emission, the feeding member 142 extending through the movable member 136 coincides with the contact member 132.

The coefficient of friction between the contact member 132 and the base member 42 is smaller than the coefficient of friction between the shaft 134 and the contact member 132. Specifically, since the contact member 132 according to the present exemplary embodiment is a ball bearing, the contact member 132 undergoes relative rotation on the shaft 134 before friction occurs between the contact member 132 and the base member 42.

The pair of supporting plates 140 are connected to each other at the respective Z-direction ends thereof by a connecting plate 147. The connecting plate 147 has an opening 147A, through which a part of the outer circumference of the contact member 132 projects to the outside. A point at the part of the contact member 132 that projects to the outside is in contact with the front surface 42A of the base member 42.

The drive source 144 is positioned across the position adjusting unit 130 from the positioning member 160 in the X direction (the drive source 144 is positioned on the near side in the device-depth direction).

Referring to FIG. 5, the light-emitting unit 41 according to the present exemplary embodiment includes measuring devices 162, which are provided adjacent to corresponding ones of the light emitters 44 in the width direction of the base member 42 (the Y direction). The measuring devices 162 each measure the distance from the light-emitting unit 41 to the surface of the photoconductor drum 32.

In the image forming apparatus 10 according to the present exemplary embodiment, the distance from the light-emitting unit 41 to the surface of the photoconductor drum 32 is measured by each of the measuring devices 162 provided at the two respective ends of the base member 42, and respective pieces of information acquired by the measurement are transmitted to a controller (not illustrated). The controller activates the position adjusting units 130 with reference to the respective pieces of information acquired by the measurement. Specifically, the controller adjusts the amounts of driving by the drive sources 144 with reference to the respective pieces of information acquired by the measurement. When the values acquired by the measuring devices 162 fall within a preset range, the controller stops the operation of the drive sources 144. The adjustment of the position of the light-emitting unit 41 by using the position adjusting units 130 may be executed when the light-emitting unit 41 is attached to the photoconductor drum 32 or after a predetermined period of time elapses from when the light-emitting unit 41 is attached to the photoconductor drum 32.

Now, a configuration featured in the image forming apparatus 10 according to the present exemplary embodiment will be described.

Referring to FIG. 1, in the image forming apparatus 10, the toner-image-forming units 22Y and 22M are provided on the upper side of the transfer belt 24. Specifically, the toner-image-forming units 22Y and 22M are arranged side by side at an interval therebetween along the horizontal portion 24A of the transfer belt 24. The toner-image-forming units 22Y and 22M according to the present exemplary embodiment are exemplary first image forming units according to the present disclosure. Correspondingly, the photoconductor drums 32Y and 32M according to the present exemplary embodiment are exemplary first image carriers according to the present disclosure. Furthermore, the light-emitting units 41Y and 41M according to the present exemplary embodiment are exemplary first light-emitting units according to the present disclosure. The photoconductor drum 32Y receives the light beam emitted from the light-emitting unit 41Y positioned thereabove in the direction of gravity. Likewise, the photoconductor drum 32M receives the light beam emitted from the light-emitting unit 41M positioned thereabove in the direction of gravity.

In the image forming apparatus 10, as illustrated in FIG. 1, the toner-image-forming units 22C and 22K are provided on the lower side of the transfer belt 24. Specifically, the toner-image-forming units 22C and 22K are arranged side by side at an interval therebetween along the angled portion 24B of the transfer belt 24. The toner-image-forming units 22C and 22K according to the present exemplary embodiment are exemplary second image forming units according to the present disclosure. Correspondingly, the photoconductor drums 32C and 32K according to the present exemplary embodiment are exemplary second image carriers according to the present disclosure. Furthermore, the light-emitting units 41C and 41K according to the present exemplary embodiment are exemplary second light-emitting units according to the present disclosure. The photoconductor drum 32C receives the light beam emitted from the light-emitting unit 41C positioned therebelow in the direction of gravity. Likewise, the photoconductor drum 32K receives the light beam emitted from the light-emitting unit 41K positioned therebelow in the direction of gravity.

The photoconductor drums 32Y, 32M, 32C, and 32K are each movable in the rotation axis direction thereof between an image forming position and a maintenance position. In the present exemplary embodiment, the rotation axis direction coincides with the device-depth direction (Z direction). Herein, the image forming position for each of the photoconductor drums 32 refers to a position where the photoconductor drum 32 is ready to rotate and to carry an image to be formed on the outer circumferential surface thereof. The maintenance position for each of the photoconductor drums 32 refers to a position where the photoconductor drum 32 is on the outside of the apparatus body by being drawn in the device-depth direction (toward the near side in the device-depth direction, for example, in the present exemplary embodiment) from the image forming position. The description that the photoconductor drum 32 is movable in the rotation axis direction does not limit the movable direction of the photoconductor drum 32 to the rotation axis direction. For example, the photoconductor drum 32 may be movable in a direction intersecting the rotation axis direction, or may be movable in any direction defined as a combination of a movement in the rotation axis direction and a movement in a direction intersecting the rotation axis direction.

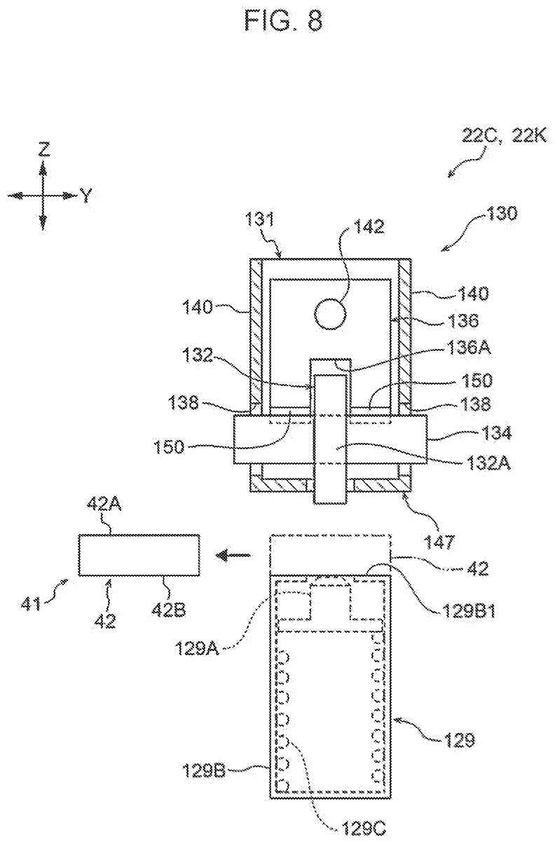

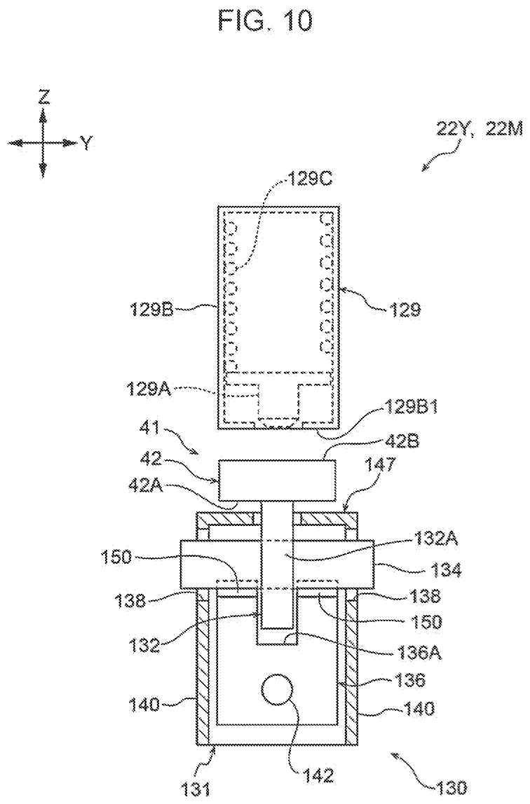

The image forming apparatus 10 includes a supporting unit that supports the light-emitting unit 41. The supporting unit is movable together with the photoconductor drum 32 in the rotation axis direction of the photoconductor drum 32. The supporting unit supports the light-emitting unit 41 that has been moved along with the photoconductor drum 32 to the maintenance position and is disabled from being positioned with respect to the photoconductor drum 32. Specifically, referring to FIG. 10, in each of the toner-image-forming units 22Y and 22M, the position adjusting units 130 (inclusive of the drive sources 144) each serve as an exemplary supporting unit (first supporting unit) and also serve as an exemplary functional component. In each of the toner-image-forming units 22C and 22K, referring to FIG. 8, the pressing units 129 each serve as an exemplary supporting unit (second supporting unit) and also serve as an exemplary functional component. Herein, the functional component refers to a component having another function in addition to the above function of supporting the light-emitting unit 41 that has been disabled from being positioned with respect to the photoconductor drum 32. That is, the position adjusting units 130 and the pressing units 129 each have a function of position adjustment or a function of pressing, in addition to the function of supporting the light-emitting unit 41.

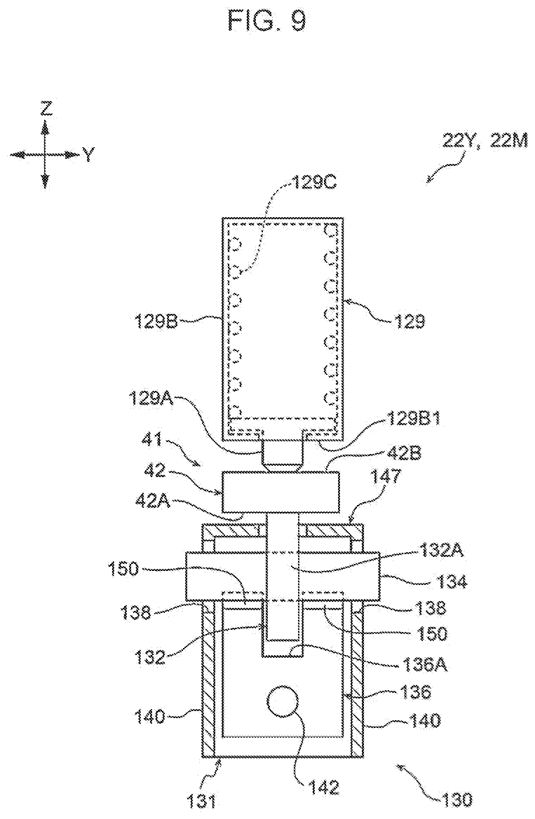

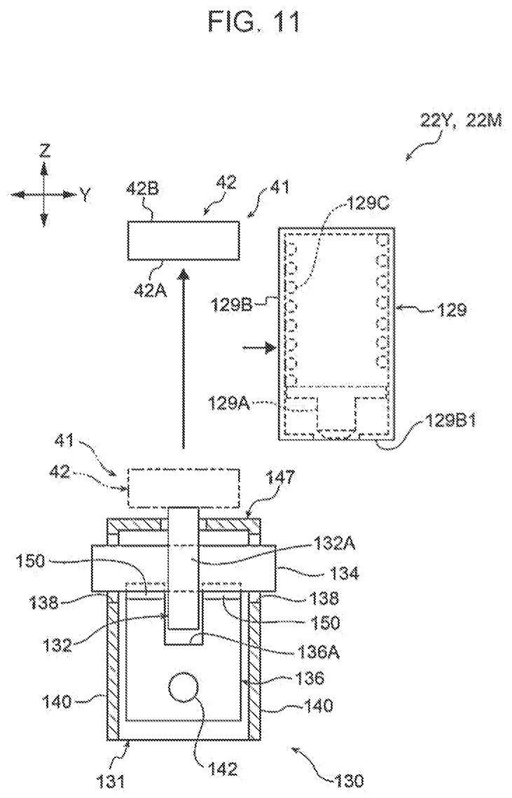

In each of the toner-image-forming units 22, when the photoconductor drum 32 is moved from the image forming position to the maintenance position, the position adjusting units 130 and the pressing units 129 also move to the maintenance position. For example, to detach the light-emitting unit 41Y from the toner-image-forming unit 22Y with the photoconductor drum 32Y being at the maintenance position (see FIG. 9), the urging members 129C included in the pressing units 129 are compressed as illustrated in FIG. 10. That is, the spring forces applied to the light-emitting unit 41Y are removed. Thus, the light-emitting unit 41Y is disabled from being held and pressed between the pressing units 129 and the position adjusting units 130. In other words, the light-emitting unit 41Y is disabled from being positioned with respect to the photoconductor drum 32Y. In this state, the light-emitting unit 41Y is temporarily supported by the contact members 132 included in the respective position adjusting units 130. Then, as illustrated in FIG. 11, the pressing units 129 are retracted from the path of movement of the light-emitting unit 41Y. After the pressing units 129 are retracted, the light-emitting unit 41Y is moved. Thus, the light-emitting unit 41Y is detached from the toner-image-forming unit 22Y.

The process of detaching the light-emitting unit 41M from the toner-image-forming unit 22M is the same as the above process of detaching the light-emitting unit 41Y from the toner-image-forming unit 22Y. Therefore, description of the process of detaching the light-emitting unit 41M from the toner-image-forming unit 22M is omitted.

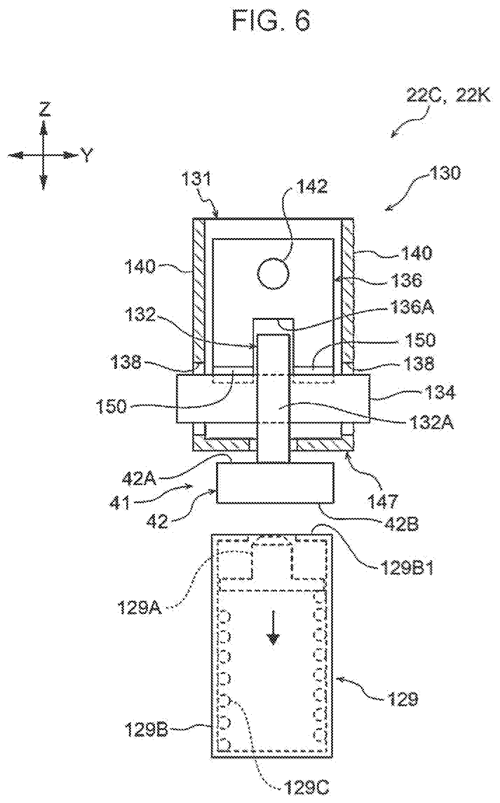

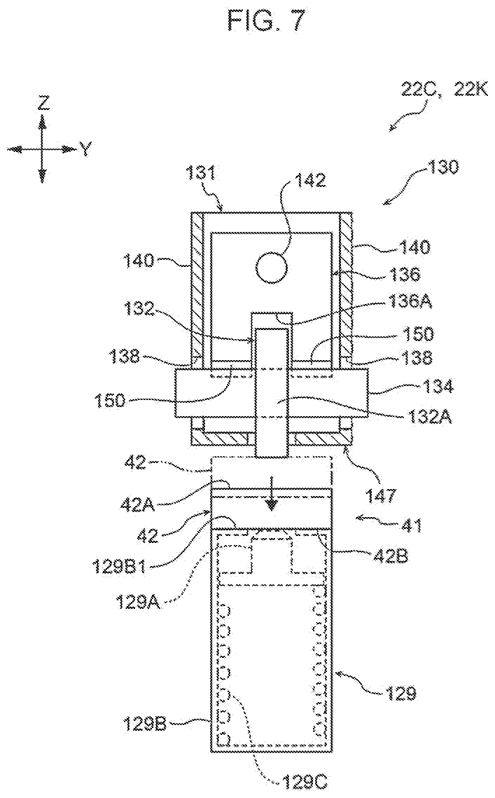

As another example, to detach the light-emitting unit 41C from the toner-image-forming unit 22C with the photoconductor drum 32C being at the maintenance position (see FIG. 6), the urging members 129C included in the pressing units 129 are compressed as illustrated in FIG. 7. That is, the spring forces applied to the light-emitting unit 41C are removed. Thus, the light-emitting unit 41C is disabled from being held and pressed between the pressing units 129 and the position adjusting units 130. In other words, the light-emitting unit 41C is disabled from being positioned with respect to the photoconductor drum 32C. In this state, the light-emitting unit 41C is in contact with an end face, 129B1, of the housing 129B of each of the pressing units 129. In other words, the light-emitting unit 41C is temporarily supported by the end faces 129B1 of the housings 129B of the pressing units 129. Then, as illustrated in FIG. 8, the light-emitting unit 41C is moved in a detaching direction (for example, a direction intersecting the direction of light emission). Thus, the light-emitting unit 41C is detached from the toner-image-forming unit 22C. Specifically, the light-emitting unit 41C is detached from the toner-image-forming unit 22C with the pressing units 129 remaining on the toner-image-forming unit 22C.

The process of detaching the light-emitting unit 41C from the toner-image-forming unit 22C is the same as the process of detaching the light-emitting unit 41K from the toner-image-forming unit 22K. Therefore, description of the process of detaching the light-emitting unit 41K from the toner-image-forming unit 22K is omitted.

Now, functions exerted by the present exemplary embodiment will be described.

In the image forming apparatus 10 including the exposure devices 40 according to the present exemplary embodiment, as described above, when the light-emitting unit 41Y is to be detached from the toner-image-forming unit 22Y, the light-emitting unit 41Y is temporarily supported by the position adjusting units 130. That is, in times of maintenance, the operator is allowed to temporarily place the light-emitting unit 41Y on the position adjusting units 130. On the other hand, when the light-emitting unit 41C is to be detached from the toner-image-forming unit 22C, as described above, the light-emitting unit 41C is temporarily supported by the pressing units 129. That is, in times of maintenance, the operator is allowed to temporarily place the light-emitting unit 41C on the pressing units 129.

In the image forming apparatus 10, the supporting units (first supporting units) for the toner-image-forming units 22Y and 22M are the position adjusting units 130, whereas the supporting units (second supporting units) for the toner-image-forming units 22C and 22K are the pressing units 129.

In the image forming apparatus 10, when the photoconductor drums 32C and 32K are each at the maintenance position with the spring forces being removed from the light-emitting units 41C and 41K, the light-emitting units 41C and 41K are supported by the end faces 129B1 of the housings 129B.

In the image forming apparatus 10, the light-emitting units 41Y and 41M are detached from the respective toner-image-forming units 22Y and 22M, with the pressing units 129 remaining on the toner-image-forming units 22Y and 22M.

In the image forming apparatus 10, the toner-image-forming units 22C and 22K are each configured such that the light-emitting unit 41C or 41K is supported by the outer circumferential surfaces (inclusive of the contact surfaces) 132A of the contact members 132 included in the position adjusting units 130.

In the image forming apparatus 10, the drive sources 144 that move the contact members 132 also move together with the photoconductor drum 32 to the maintenance position.

In the image forming apparatus 10, the position adjusting units 130 serving as the first supporting units that support the photoconductor drums 32Y and 32M are components that are different from the pressing units 129 serving as the second supporting units that support the photoconductor drums 32C and 32K. In the image forming apparatus 10, if, for example, the first supporting unit and the second supporting unit are configured as the same component, a consideration for providing, to the supporting unit, a U-shaped portion for holding the light-emitting unit may be necessary.

In the image forming apparatus 10, the light-emitting units 41 include the positioning members 160 that determine the positions of the light-emitting units 41 in the direction orthogonal to the direction of light emission.

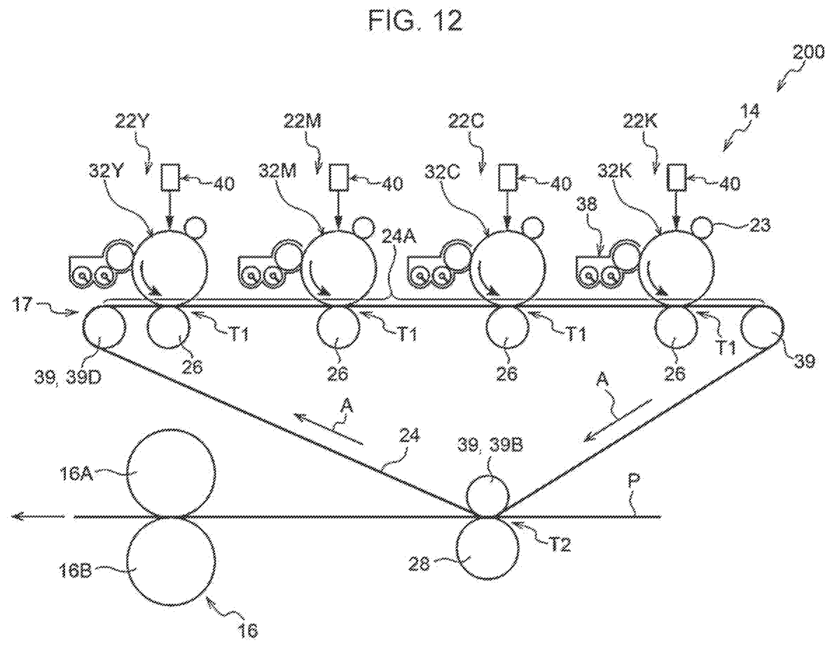

While the image forming apparatus 10 according to the above exemplary embodiment includes, as illustrated in FIG. 1, the toner-image-forming units 22Y and 22M arranged along the horizontal portion 24A of the transfer belt 24 and the toner-image-forming units 22C and 22K arranged along the angled portion 24B of the transfer belt 24, the present disclosure is not limited to such a configuration. For example, an image forming apparatus 200 illustrated in FIG. 12 is also applicable, in which the toner-image-forming units 22Y, 22M, 22C, and 22K are arranged side by side at intervals from one another along the horizontal portion 24A of the transfer belt 24.

In the image forming apparatus 10 according to the above exemplary embodiment, in times of maintenance, the light-emitting units 41Y and 41M are temporarily supported by the position adjusting units 130, whereas the light-emitting units 41C and 41K are temporarily supported by the pressing units 129. The present disclosure is not limited to such a configuration. For example, the light-emitting units 41 may be supported by brackets intended for temporary support and provided on frames of the toner-image-forming units 22.

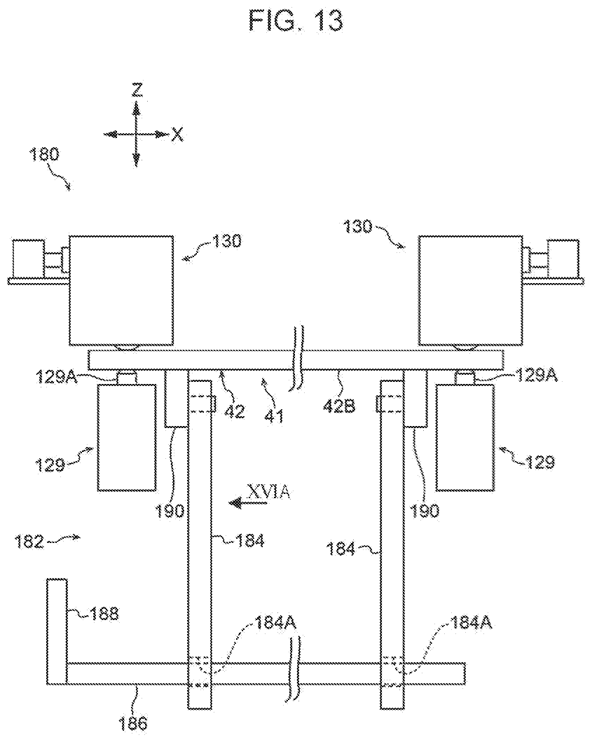

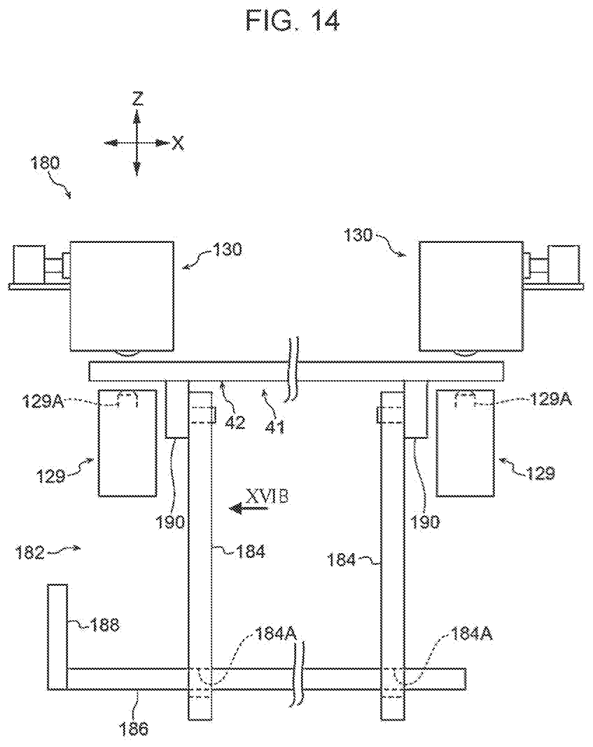

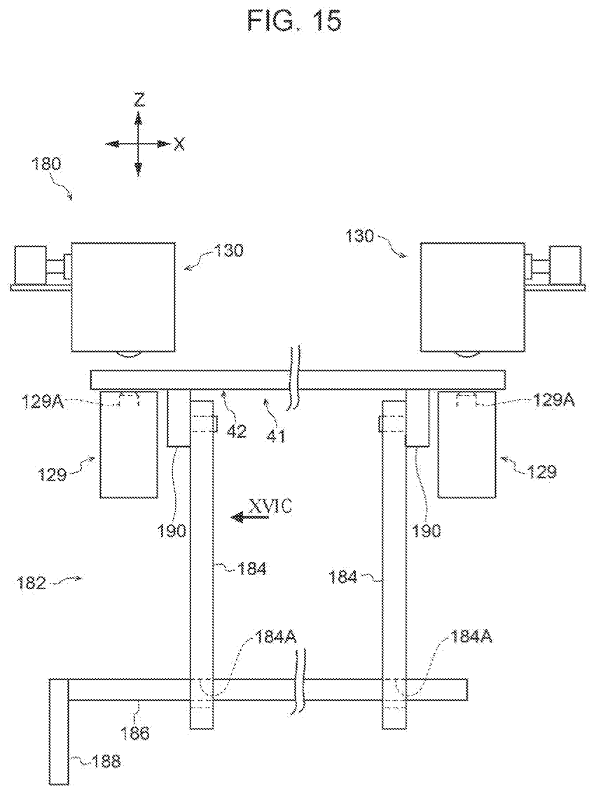

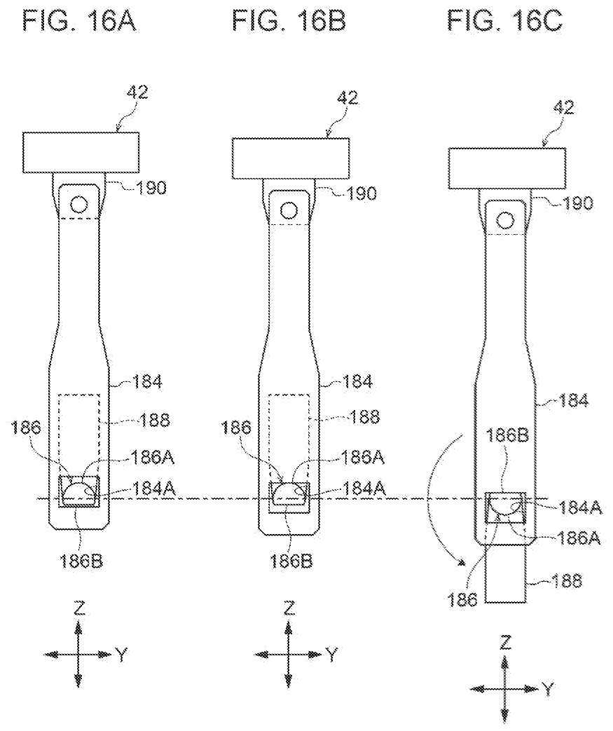

FIGS. 13 to 16 illustrate an exposure device 180 according to a modification, which indicates that the light-emitting unit 41 may be temporarily supported by a separating unit 182. As illustrated in FIGS. 13 to 15, the separating unit 182 includes a pair of arms 184, a shaft 186, and an operation lever 188. The pair of arms 184 are each connected at one end thereof to a corresponding one of brackets 190, which are provided on the back surface 42B of the base member 42 of the light-emitting unit 41 and near the two respective ends of the base member 42 in such a manner as to be rotatable about an axis extending in the device-depth direction. The pair of arms 184 each have at the other end thereof a rectangular through-hole 184A, through which the shaft 186 extends. The shaft 186 has a cross section defined by an arc surface 186A and a flat surface 186B. That is, the shaft 186 has a D-shaped cross section, for example. The operation lever 188 is attached to an end of the shaft 186 that is on the near side in the device-depth direction. When the operation lever 188 is rotated from an angular position illustrated in FIG. 16A to an angular position illustrated in FIG. 16C, the light-emitting unit 41 is moved away from the photoconductor drum 32. When the photoconductor drum 32 is at the maintenance position, the separating unit 182 is allowed to perform a separating operation, in which the light-emitting unit 41 is moved away from the photoconductor drum 32. The toner-image-forming unit 22 includes a stopper (not illustrated), which does not allow the separating operation by the separating unit 182 to be performed before the photoconductor drum 32 is moved to the maintenance position. Now, a process of retracting the light-emitting unit 41 in the exposure device 180 will be described. First, the photoconductor drum 32, the position adjusting units 130, and the pressing units 129 are moved to the maintenance position (see FIG. 13). The relationship between either of the arms 184 and the shaft 186 in this state is illustrated in FIG. 16A. Then, as illustrated in FIG. 14, the coil springs, serving as the urging members 129C, provided in the pressing units 129 are compressed. That is, the light-emitting unit 41 is disabled from being positioned. In this state, the light-emitting unit 41 is supported by the pair of arms 184 supported by the shaft 186. Specifically, as illustrated in FIG. 16B, the arc surface 186A of the shaft 186 comes into contact with the wall surfaces of the through-holes 184A provided in the respective arms 184, whereby the light-emitting unit 41 is supported. Subsequently, the operation lever 188 is rotated as illustrated in FIG. 15. Accordingly, as illustrated in FIG. 16C, the flat surface 186B of the shaft 186 comes into contact with the wall surfaces of the through-holes 184A of the arms 184, whereby the light-emitting unit 41 is supported by the arms 184 and is moved away, i.e., retracted, from the photoconductor drum 32. In the image forming apparatus employing the exposure device 180, the separating unit 182 serves as the supporting unit. Furthermore, when the photoconductor drum 32 is at the image forming position, the separating operation is prohibited by the stopper (not illustrated). Furthermore, the position adjusting units 130, the pressing units 129, and the photoconductor drum 32 are configured to move together.

While the image forming apparatus according to the above exemplary embodiment relates to a configuration in which three light emitters are provided on a base member, the present disclosure is not limited to such a configuration. For example, any of the following is applicable: a configuration in which one light emitter is provided on a base member, a configuration in which two light emitters are provided on a base member, and a configuration in which four or more light emitters are provided on a base member. The positions of the plurality of light emitters provided on the base member are defined in any way.

The features of the image forming apparatus according to the above exemplary embodiment may also be applied to elements intended for photolithography, which is performed in the following: for example, the formation of a color filter in a process of manufacturing a liquid-crystal display (LCD), exposure to be performed on a dry film resist (DFR) in a process of manufacturing a thin-film transistor (TFT), exposure to be performed on a dry film resist (DFR) in a process of manufacturing a plasma display panel (PDP), exposure to be performed on a photosensitive material such as photoresist in a process of manufacturing a semiconductor device, exposure to be performed on a photosensitive material such as photoresist in platemaking for printing such as gravure printing other than offset printing, and exposure to be performed on a photosensitive material in a process of manufacturing clock components. Photolithography refers to a technique in which pattern exposure is performed on a surface of a substance over which a photosensitive material is provided, whereby a pattern including regions that have been exposed to light and regions that have not been exposed to light is obtained.

The image forming apparatus described above may be used with either a photon-mode photosensitive material, with which information is directly recorded by exposure, or a heat-mode photosensitive material, with which information is recorded with heat generated by exposure. The light source of the image forming apparatus may be an LED device or a laser device, depending on the object of exposure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus comprising:
a rotatable image carrier on an outer circumferential surface of which an image is to be formed;
a light-emitting unit including a base member extending in a rotation axis direction of the image carrier, and a plurality of light-emitting devices provided on the base member and configured to apply light to the outer circumferential surface of the image carrier; and
a supporting unit configured to move together with the image carrier in the rotation axis direction and to support the light-emitting unit when the image carrier and the light-emitting unit are disabled from being pressed in the rotation axis direction to be positioned with respect to the image carrier.

2. The image forming apparatus according to claim 1,
wherein the supporting unit is a functional component having another function in addition to a function of supporting the light-emitting unit that is disabled from being positioned with respect to the image carrier, the another function being exerted when the image carrier is at the image forming position.

3. The image forming apparatus according to claim 1, further comprising:
an adjusting unit configured to come into contact with the light-emitting unit and to adjust a position of the light-emitting unit in a direction parallel to a direction of light emission by moving the light-emitting unit in the direction parallel to the direction of light emission; and
a pressing unit provided across the light-emitting unit from the adjusting unit and configured to press the light-emitting unit in the direction of light emission,
wherein the supporting unit serves as the pressing unit or the adjusting unit.

4. The image forming apparatus according to claim 1,
wherein the supporting unit serves as a pressing unit configured to press the light-emitting unit in a direction of light emission, and
wherein the pressing unit includes a spring that presses the light-emitting unit in the direction of light emission, and a cylindrical body that houses the spring, and
wherein when the image carrier is at the maintenance position with a spring force of the spring being removed from the light-emitting unit, the pressing unit supports the light-emitting unit at an end face of the cylindrical body.

5. The image forming apparatus according to claim 2,
wherein the supporting unit serves as a pressing unit configured to press the light-emitting unit in a direction of light emission, and
wherein the pressing unit includes a spring that presses the light-emitting unit in the direction of light emission, and a cylindrical body that houses the spring, and
wherein when the image carrier is at the maintenance position with a spring force of the spring being removed from the light-emitting unit, the pressing unit supports the light-emitting unit at an end face of the cylindrical body.

6. The image forming apparatus according to claim 3,
wherein the supporting unit serves as the pressing unit configured to press the light-emitting unit in the direction of light emission, and
wherein the pressing unit includes a spring that presses the light-emitting unit in the direction of light emission, and a cylindrical body that houses the spring, and
wherein when the image carrier is at the maintenance position with a spring force of the spring being removed from the light-emitting unit, the pressing unit supports the light-emitting unit at an end face of the cylindrical body.

7. The image forming apparatus according to claim 4,
wherein the light-emitting unit and the pressing unit are separate bodies, and
wherein the light-emitting unit is detachable from the image forming apparatus with the pressing unit remaining on the image forming apparatus.

8. The image forming apparatus according to claim 5,
wherein the light-emitting unit and the pressing unit are separate bodies, and
wherein the light-emitting unit is detachable from the image forming apparatus with the pressing unit remaining on the image forming apparatus.

9. The image forming apparatus according to claim 6,
wherein the light-emitting unit and the pressing unit are separate bodies, and
wherein the light-emitting unit is detachable from the image forming apparatus with the pressing unit remaining on the image forming apparatus.

10. The image forming apparatus according to claim 2,
wherein the functional component serves as an adjusting unit configured to come into contact with the light-emitting unit and to adjust a position of the light-emitting unit in a direction parallel to a direction of light emission by moving the light-emitting unit in the direction parallel to the direction of light emission,
wherein the adjusting unit includes a contact member configured to come into contact with the light-emitting unit and that causes the light-emitting unit to move in the direction parallel to the direction of light emission, and
wherein the adjusting unit or the adjusting unit serving as the functional component supports the light-emitting unit at a contact surface of the contact member.

11. The image forming apparatus according to claim 3,
wherein the adjusting unit includes a contact member configured to come into contact with the light-emitting unit and that causes the light-emitting unit to move in the direction parallel to the direction of light emission, and
wherein the adjusting unit or the adjusting unit serving as the functional component supports the light-emitting unit at a contact surface of the contact member.

12. The image forming apparatus according to claim 10, further comprising:
a driving unit configured to move the contact member,
wherein the driving unit is configured to move together with the image carrier to the maintenance position.

13. The image forming apparatus according to claim 11, further comprising:
a driving unit configured to move the contact member,
wherein the driving unit is configured to move together with the image carrier to the maintenance position.

14. The image forming apparatus according to claim 1, further comprising:
a first image carrier to which light is applied from the light-emitting unit, the light-emitting unit being positioned above the first image carrier in a direction of gravity;
a second image carrier to which light is applied from another light-emitting unit that is positioned below the second image carrier in the direction of gravity;
a first supporting unit that supports the first image carrier; and
a second supporting unit that supports the second image carrier,
wherein the first supporting unit and the second supporting unit are components that provide respectively different functions to the respective image carriers.

15. The image forming apparatus according to claim 2, further comprising:
a first image carrier to which light is applied from the light-emitting unit, the light-emitting unit being positioned above the first image carrier in a direction of gravity;
a second image carrier to which light is applied from another light-emitting unit that is positioned below the second image carrier in the direction of gravity;
a first supporting unit that supports the first image carrier; and
a second supporting unit that supports the second image carrier,
wherein the first supporting unit and the second supporting unit are components that provide respectively different functions to the respective image carriers.

16. The image forming apparatus according to claim 1, further comprising:
a positioning member provided on the base member and that determines a position of the light-emitting unit in a direction orthogonal to the direction of light emission.

17. The image forming apparatus according to claim 2, further comprising:
a positioning member provided on the base member and that determines a position of the light-emitting unit in a direction orthogonal to the direction of light emission.

18. The image forming apparatus according to claim 1, further comprising:
a separating unit connected to the light-emitting unit and configured to move the light-emitting unit away from the image carrier, the separating unit serving as the supporting unit.

19. The image forming apparatus according to claim 18,
wherein when the image carrier is at the maintenance position, the separating unit is allowed to perform a separating operation in which the light-emitting unit is moved away from the image carrier.

20. The image forming apparatus according to claim 19, further comprising:
an adjusting unit configured to come into contact with the light-emitting unit and to adjust a distance between the light-emitting unit and the outer circumferential surface of the image carrier by moving the light-emitting unit in a direction parallel to a direction of light emission; and
a pressing unit provided across the light-emitting unit from the adjusting unit and configured to press the light-emitting unit in the direction of light emission,
wherein the adjusting unit and the pressing unit are configured to move together with the image carrier in the rotation axis direction.
